(19) United States
(12) Patent Application Publication
(10) Pub. No.: US 2003/0177439 A1
(43) Pub. Date: Sep. 18, 2003

(54) Byte-count truncate and append

(76) Inventor: Joseph Dale Helmick, Columbus, OH (US)

Correspondence Address: Joseph D. Helmick, 5253 E. Broad St. Apt.109, Columbus, OH, 43213, US

(21) Appl. No.: 10/095,133

(22) Filed: Mar. 12, 2002

(51) Int. Cl. G06F 15/00

(52) U.S. Cl. 715/500

(57) ABSTRACT

After activation of the OK button in print mode of a pdf document, truncation of the application-PostScript interpreter system during encapsulation, printer driver translations and/or spooling of Acrobat or Acrobat-QuickTime-pdf is introduced to short-circuit a network operating system and create an electromagnetic potential as an append technique by using the routers and gateways of the Internet as an antenna. An ingressing modulation of encrypted signals from across an electromagnetic field is appended to the split data structure(s) of the truncated format procedure in a transmission of novel 4-dimensional cosmic particles.

### REFERENCES CITED

U.S. Patent Documents

| | | | |
|---|---|---|---|
| 6042774 | Mar. 28, 2000 | Wilkening, et al. | 264/497 |
| 5537143 | Jul. 16, 1996 | Steingold, et al. | 725/119 |
| 5008679 | Apr. 16, 1991 | Effland, et al. | 342/353 |
| 5570099 | Oct. 29, 1996 | DesJardins | 342/378 |
| 5594452 | Jan. 14, 1997 | Webber, et al. | 342/353 |
| 4799062 | Jan. 17, 1989 | Sanderford, Jr., et al. | 342/450 |
| 6018312 | Jan. 25, 2000 | Haworth | 342/353 |
| 6301232 | Oct. 9, 2001 | Dutta | 370/321 |
| 4161738 | Jul. 17, 1979 | Kokaji | 346/74.2 |
| 4536773 | Aug. 20, 1985 | Kokaji, et al. | 346/74.2 |
| 4698755 | Oct. 6, 1987 | Okazaki, et al. | 358/1.13 |
| 4992957 | Feb. 12, 1991 | Aoyama,etal. | 358/1.13 |
| 5307498 | Apr. 26, 1994 | Eisen, et al. | 717/4 |
| 5806067 | Sept. 8, 1998 | Connor | 707/100. |
| 6331856 | December 2001 | VanHook, et al. | 345/503. |
| 5005119 | April 1991 | Rumbaugh et al | 364/200. |
| 5175828 | December 1992 | Halletal | 395/375. |
| 5649203 | July 1997 | Sites | 395/709. |
| 5313614 | May 1994 | Goettelmann et al | 395/500. |
| 5598560 | January 1997 | Benson | 395/707. |

### Other References

Adobe Systems Inc., PostScript Language Reference third edition, Addison-Wesley, Reading, 999, pp.62, 69, 21-52, 11-21, 70-72, 151, 182-192, 197, 564, 638, 518-519.

Acrobat Writer Help pages, Adding Interactive Features, pp.399-406.

V. Lindell et. al., Electromagnetic Waves in Chiral and Bi-Isotropic Media, ARTECHOUSE INC., Norwood, 1994

D.J. Griffiths, Introduction to Electrodynamics, Prentice Hall, Englewood Cliffs, 1989 pp.378-380.

Kraus/Fleisch ch, Electromagnetics with Applications, McGraw-Hill, Boston, 1999 p.172.

B.R. Martin & G. Shaw, Particle Physics, John Wiley & Sons Ltd., Chichester, 1992, pp.9-16.

M. Roos, Introduction to Cosmology, Second edition, John Wiley & Sons Ltd., Chichester, 1997, pp. 60, 82-100, 98, 141, 153-156, 214.

NASA, Cosmic Journeys, To the Edge of Gravity, Space and Time, Structure and Evolution of the Universe Roadmap: 2003-2023, September 1999, p.18.

M. Y. Han, The Probable Universe, TAB Books, Blue Ridge Summit, 1993, p.127.

### DESCRIPTION

### BACKGROUND OF THE INVENTION

### FIELD OF THE INVENTION

Byte-count truncate and append is derived from a network operating system with pdf document downloaded by Acrobat (registered trademark of Adobe) reader and/or Acrobat with embedded QuickTime (registered trademark of Apple) multimedia software and is connected to truncation of the application-PostScript (registered trademark of Adobe) interpreter system and its environment during encapsulation, printer driver translations and/or spooling by mouse click or keyboard function on the cancel button of the page count-down window after a click on OK in the print properties dialogue box in a short-circuiting of the network operating system to print part of the pdf document plus the appended modulation.

### SUMMARY OF THE INVENTION

The invention is a method (PostScript-compatible) and article of manufacture from operating a pdf file link in a webpage that uses Acrobat or Acrobat with embedded QuickTime to download the document. By embedding QuickTime in Acrobat, the Acrobat initialization frame and the QuickTime initialization frame open automatically one after the other without any additional clicks. With the pdf document downloaded, by clicking on the file dropdown box, the print function is selected. All pages of the document are selected in the print window and click on OK.

The objective is that by user truncation of the application-PostScript interpreter system during encapsulation, translation by the printer drivers, and/or spooling, (FIG. 2) a probability of splitting a data structure (e.g. parentheses, brackets, curly brackets) and of appending an ingressing modulation is created. Precise timing and placement of user truncation effectively splits a data structure, short-circuits the programming interface in the network operating system with Internet routers and gateways and creates an electromagnetic potential that functions as a detector-receiver of an antenna. The ingressing modulation is attracted to the potential, appends to the sequence of objects in the split data structure by a logical or combinatorial means to continue the printing of the pdf document up to the point of truncation plus the appended ingressing modulation. (FIG. 1)

### BRIEF DESCRIPTION OF THE DRAWINGS

FIG. 1 shows the encryption of cosmic particles appended by the ingressing modulation.

FIG. 2 shows the network operating system diagram of interactive methods.

### DETAILED DESCRIPTION OF THE INVENTION

Truncation of application-PostScript interpreter system during encapsulation, printer driver translations and/or spooling of Acrobat or Acrobat-QuickTime pdf is timed and placed to short-circuit the system by hitting on and splitting a data structure (e.g. parentheses, brackets, curly brackets) in a format statement of procedure objects. The split data structure exposes an electromagnetic potential in the programming interface (e.g. dynamic relation between print manager, spooler and application-PostScript interpreter system) and over the network operating system of routers and gateways of the Internet. Using the Internet as an antenna, the ingressing modulation appends to the sequence of objects in the split data structure (e.g. “Arrays of higher dimension, greater than one-dimensional arrays, can be constructed by using arrays as elements of arrays, nested to any depth” (Adobe, p.53); “putinterval overwrites a subinterval of one array or string with contents of another”; “an operator, getinterval, that creates a new array object whose value is a subinterval of an existing array” (Adobe, p.39, 53); and “a reference with an out-of-bounds index that results in a rangecheck error” (Adobe, p.53) was circumvented, due to the short circuit) and prints on the page following the truncated text.

In this case with an NT Server, the printer drivers are listed in Lexmark Lex ps, version 4.31, a PostScript LanguageLevel 2 mode that supports path construction, and consists of 15 files. But the system can be used with any network operating system or page description language including LanguageLevel 3 of PostScript. The application-PostScript interpreter system during encapsulation, translation by the printer drivers, and/or spooling of any system can be truncated by timing the cancel button of the page count-down window so that timing corresponds to bit-placement in truncating the data structure and so that the ingressing modulation has an exposed (fragmented) sequence of objects to which the modulation can append by a logical or combinatorial means.

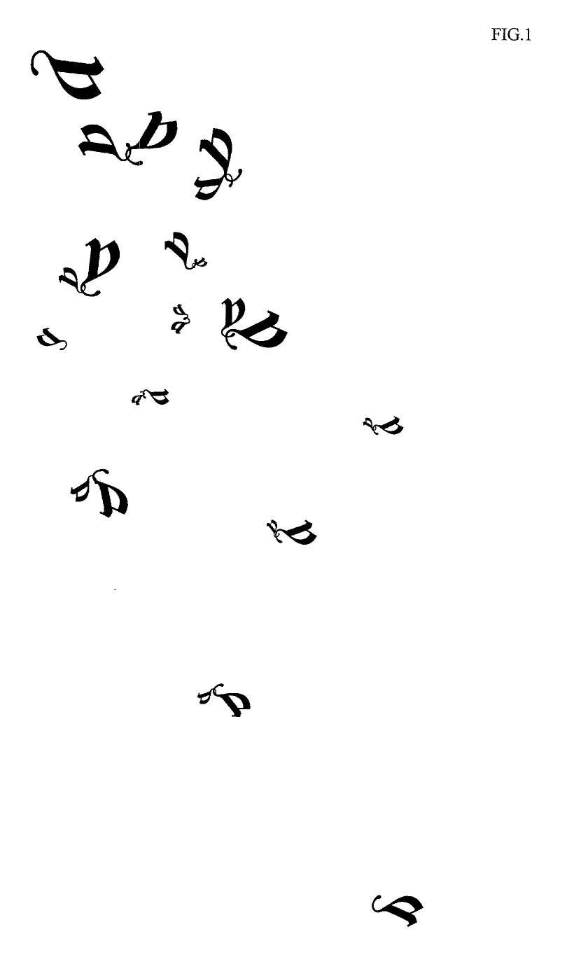

Using a network operating system with truncation as a tool to configure the Internet as an antenna, a detector receives the ingressing modulation and reveals a novel individual, a sufficient variety of species, genus, family, order and kingdom of cosmic particles with a multiplicity of sizes and orientations. (FIG. 1) An electromagnetic potential across TCP/IP dynamic heterarchical routers and gateways of the Internet receives the ingressing modulation from an unknown source. (Explanations include a visible neutrino of dark matter, condensation from an exceedingly small volume of an atomic particle's electromagnetic reaction in space, deceleration of optical particles moving at the speed of light, or a dispersion of the particles in a 4-dimensional curve suggesting a specific temperature of reaction.)

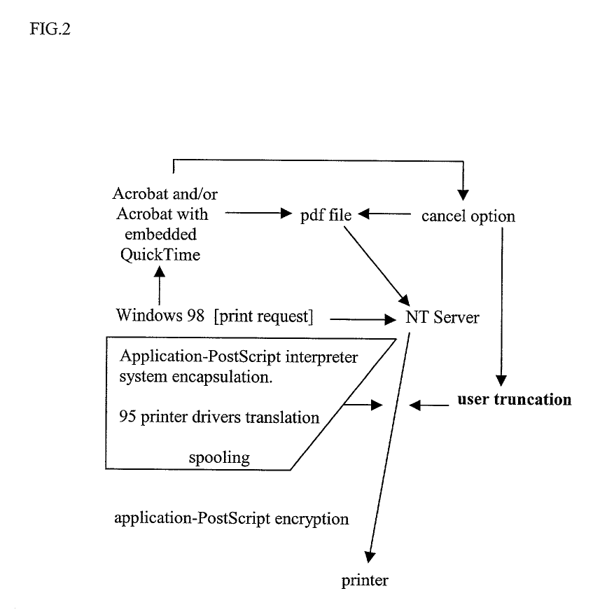

User truncation of the application-PostScript interpreter system during encapsulation, translation by the printer drivers, and/or spooling from an NT server on a Windows 98 network running Acrobat or Acrobat with embedded QuickTime (FIG. 2) precipitates a short-circuit that results in a junction (e.g. the dynamic relation between print manager, spooler and application-PostScript interpreter system) across an electromagnetic field (e.g. between positive and negative fields as in a satellite semiconductor). The appended modulation results in an encryption as realized in FIG. 1 and presents a “new extension of quantum electrodynamics in the world of photon behavior.” (Han p.127)

After execution of the print mode of Acrobat or Acrobat-QuickTime pdf, a mouse click or keyboard function on the cancel button of the page count-down window during the programming interface of the application-PostScript interpreter system during encapsulation, translation by the printer drivers, and/or spooling determines the point of truncation and splitting of parentheses, curly brackets or other data structures of a format with procedure objects and presents an exposed potential to which an ingressing modulation logically or combinatorially appends as an encryption. (FIG. 1, FIG. 2) The original document to download and print was 8 pages total length, but only 2 pages of the document plus the appended particles were printed. A testing program to time truncation according to placement on bits with data structures will determine which of the split data structures' locations ¼ of the total (2 of 8 total pages), and is the point to begin analysis of the prolog and script. The splitting of a data structure and the appending of the encrypted ingressing modulation also presents a probability in a game of chance.

In FIG. 1, the first and second dimensions are the xy plane of the paper and the third dimension of size is defined as depth even in cases where the multiplicity of different sizes of the 2 particles are hooked or entangled. The first, second and third dimensions are Euclidean by definition and describe the translation component of the curve. The fourth dimension is an orientation that equals the angular variable, is non-Euclidean by definition and describes the radial component of the cosmic particles' spin. In the prior art there is no method or process to construct a novel data structure, procedure, sequence of objects and/or software to produce 4-dimensional particles.

During the appending of the modulation to the modified array or modified packed array, the short-circuiting of the procedure object invoked any or a combination of the following construction operators that resulted in the multiplicity of orientations of FIG. 1: show, FdepVector, newpath, setbox, lineto, moveto, arcn, arc, arct, arcto, curveto and closepath; and/or uappend, ucache, upath, ustroke, ustrokepath, rcurveto, rlineto, rmoveto, that appends a “section of a cubic Bezier curve to the current path where the operands are relative displacements from the current path” (Adobe, pp.191, 564-565) as an orientation that equals the angular variable, is non-Euclidean by definition and describes the radial component of the cosmic particles' spin. Also the PostScript-compatible procedure with modified array or modified packed array invoked any or a combination of the transformation construction operators; translate, rotate, scale, concat.

“Text is described according to the imaging model and the correspondence between source image coordinate system (image space) and user space is defined by linear transformation. (Adobe, pp.184-189) Translate, rotate, (Roos, pp.143-145) (Adobe, pp.182-189) and scale concatenate the current transformation matrix with a matrix describing the desired transformation producing a new matrix that combines the original and additional transformations.” (Adobe, p.294) The image is mapped and placed on the output page by invoking PostScript operators translate, rotate, scale that transform user space. (Adobe, pp.293-296) Pixel coordinates according to rectangle boundaries are calculated according to FIG. 1 and by working to the split data structures with fragmented objects, strings and/or arrays of numeric operands will produce combinations that can be verified by comprehensive testing.

“An encoded user path is an array of 2 string objects or an array and a string, and ufil interprets the encoded data structure. The elements of an encoded user path are data strings or data arrays of numeric operands. If the elements are a data string, the interpretation is as an encoded number string, and if a data array, the elements are all numbers used in a sequence.” (Adobe, pp.200-203) The appending modulation's range of frequencies, amplitude and phase are compatible with the split or fragmented structure's data string or data array. “A wave form that incorporates a range of frequencies will change shape as it progresses because waves of different frequencies travel at different speeds in a dispersive medium.” (Griffiths, pp.378-380)

Data structures like parentheses or curly brackets are broken or split off as in the last term of a series in the inductive step of mathematical induction and expose a potential in the form of a fragmented executable array or packed array for a logical or combinatorial encryption with the ingressing modulation. For example, save and restore operations, executed by the server that accomplishes encapsulation, apply to the Encoding array. From the approximate point of truncation, ±1 page is reasonable for the upper and lower bounds of the data structure search, but every data structure is tested. Thus, a data structure, procedure, sequence of objects, program and/or corresponding software is constructed by analyzing the range of data structures, the timing at which the structures occur in the programming interface of application-PostScript interpreter system, translation by the printer drivers, and/or spooling, and testing with user truncation by the cancel button of the page count-down window after a click on OK in the print properties dialogue box.

The invention consists of a web page with a link to another page. The second page has a link for a pdf document using Acrobat and a link for a mov clip using QuickTime. One step of the invention is to embed QuickTime in Acrobat so that when first downloaded, the Acrobat initializing frame and the QuickTime initializing frame open automatically one after the other without any intermediate clicking. Use of Acrobat and/or Acrobat with embedded QuickTime is sufficient to set initial conditions for the short-circuiting and appending of the ingressing modulation. The operating system has finished downloading Acrobat and/or Acrobat with embedded QuickTime and the pdf document is ready to print.

The next step to print the pdf document is to select the print command from the file dropdown box, select all for page numbers to be printed in the corresponding window, and click on OK to start encapsulation by application-PostScript interpreter system, the printer driver translations and spooling of an Acrobat or Acrobat with embedded QuickTime pdf file.

The key to this interactive system is to short circuit by mouse or keyboard the dynamic relation between print manager, spooler and application-PostScript interpreter system by activating the print cancel button of the page count-down window after a click on OK in the print properties dialogue box. The objective of the game of chance is a probability to truncate a data structure so that the system is short-circuited, a data structure is split, and an electromagnetic potential is created over the Internet routers and gateways as in a detector-receiver of an antenna. An ingressing modulation logically or combinatorially appends to the split data structure and fragmented sequence of objects as an encryption and continues to the printer producing the original pdf document up to and including the junction of the split procedure object appended with the ingressing modulation. (FIG. 1)

I claim:

1. A computer network operating method with user interaction to obtain novel 4-dimensional cosmic particles (FIG. 1) including the multiplicity of different sizes of the hooked and/or entangled particle pairs and of the single particles where an orientation that equals the angular variable is non-Euclidean by definition and describes the radial component of the cosmic particle's spin by truncation of a dynamic relation between print manager, spooler and application-interpreter system during encapsulation, printer driver translations and/or spooling of a reader or reader with embedded multimedia software in sending the file to the printer, short-circuiting the network operating system, and splitting a data structure(s) (e.g. parentheses, brackets, curly brackets) of format procedure objects to which the ingressing modulation appends as an encryption.

2. The claim of 1 in which the method, using the network operating system and the herterarchical design of Internet routers and gateways, functions as a detector, receiver and antenna.

3. The product made by the method of claim 1 for the 4-dimensional cosmic particles of FIG. 1 including the multiplicity of different sizes of the hooked and/or entangled particle pairs and of the single particles in a new classification from individual through a sufficient variety of species, genus, family, order, and kingdom.

4. The claim of 1 from which a game of chance with a probability to produce the appended modulation is set forth.

5. An article of manufacture in computer readable medium of a novel data structure, operator, operands, format statement, procedure object of modified arrays or modified packed arrays, path, and/or corresponding and compatible software program.

6. The claim of 5 such that a novel alpha (character) data is created.

8. The claim of 5 such that the printer drivers take the appended format procedure object and tells the printer precisely where to score the ink.

9. The claim of 5 such that a path defined by a procedure that invokes operators and their coordinate operands are expressed as literal numbers for constructing the path.

10. The claim of 9 such that any or a combination of construction operators appends a section of a cubic curve to the current path.

11. An article of manufacture in computer readable medium for a call-and-stop program to test and time truncation according to placement on bits with data structures in the dynamic relation between print manager, spooler and application-interpreter system during encapsulation, printer driver translations and/or spooling of a reader and/or reader with embedded multimedia software so that determination of data structure(s) (e.g. parentheses, brackets, curley brackets) of the format procedure objects, which are split so that an ingressing modulation is appended, is determined.

12. The claim of 11 from which an article of manufacture in computer readable medium for a short-circuiter program, which upon truncation, splits a data structure, short-circuits the network operating system, creates an electromagnetic potential and appends the ingressing modulation.

13. The claim of 12 from which a semiconductor that short circuits, is of comparatively low resistance, and acting as a shunt is accidentally or intentionally connected between points on a circuit between which the resistance is normally much greater.
